(19) United States
(12) Patent Application Publication
(10) Pub. No.: US 2005/0235555 A1
(43) Pub. Date: Oct. 27, 2005

(54) Insect removal tape and method of using insect removal tape

(76) Inventor: Marni Hurwitz, Far Hills, NJ (US)

Correspondence Address: ERNEST D. BUFF;ERNEST D. BUFF AND ASSOCIATES, LLC., 231 SOMERVILLE ROAD, BEDMINSTER, NJ, 07921, US

(21) Appl. No.: 10/849,044

(22) Filed: Nov. 15, 2004

Related U.S. Application Data
(63) Continuation of application No. 09/737,461, filed on Dec. 18, 2000, now abandoned.

(51) Int. Cl. A01M 1/14

(52) U.S. Cl. 43/114

(57) ABSTRACT

An adhesive device is provided for removing small insects from a surface. The adhesive device contains an active ingredient for debilitating or killing insects. The adhesive device may be in the form of an adhesive tape, wherein a desired length of tape is applied to a surface so that the insect is covered and immobilized with the adhesive tape. After a predetermined amount of time, the insect is debilitated or killed and the tape is removed. Since the tape is easily removed and folded over the insect, it is possible to avoid direct contact with the insect.

### BACKGROUND OF THE INVENTION

1. Field of the Invention

This invention generally relates to a device for removing a small insect from a surface, such as an animal, person, wall, or other object. In particular, an adhesive tape is applied to the surface on which the insect is present so that the tape adhesively immobilizes the insect. The tape has an agent that debilitates or kills the insect. Since the insect adheres to the tape, it is easily disposed of without having to directly touch the insect.

2. Background of the Related Art

Small insects, such as ticks, fleas, mites, etc. are known to annoy animals and persons and disturb the public health. The only known methods for removing insects from animals or persons is to extract the insect with tweezers or fingers. Insects can be killed or removed from homes by using sprays, swatting or traps. But these methods are undesirable for a number of reasons. In particular, it may be difficult to extract an insect from an animal because this requires the animal to sit still for a prolonged period of time. Also, extraction may require a person to directly contact the insect with their fingers, which increases the risk of being bitten or stung. Also, when attempting to pull an insect, such as a tick, off the surface of the animal, a portion of the tick may still remain embedded in the animal's skin.

If the insect is in the home, toxic sprays are undesirable because a large area may be exposed to the spray when only a small insect needs to be immobilized. Also, traps are only effective for the immediate area surrounding the trap and the insect must go to the trap on its own accord before it can be immobilized. Swatting an insect is difficult and may leave unattractive marks on walls or other surfaces of the home.

Also, with most of these methods, one must touch the insect in order to remove it and this increases the risk of getting bitten or stung.

### SUMMARY OF THE INVENTION

The present invention overcomes the above problems by providing an adhesive tape with agents for debilitating, immobilizing and/or killing an insect.

In particular, the objective of the present invention is to provide a device for quickly and easily removing small insects from an animal, person or inanimate surface, without directly touching the insect.

In achieving the above objective, a tape is provided having an adhesive on one side. The adhesive side of the tape may contain an agent which will debilitate or kill the insect. The tape may be clear or of a light color, so that the insect is visible through the tape.

The tape may be stored on a spool, so that a desired length of the tape can be dispensed from a dispenser. The dispenser may have a serrated edge for tearing a desired length of the tape. Also, a handheld roller may be used to store the tape, so that the tape can be directly rolled onto the surface.

Also, the tape may have perforations so that a desired length of tape is easily torn away from the roll.

### BRIEF DESCRIPTION OF THE DRAWINGS

The above objects and advantages of the present invention will become more apparent by describing in detail a preferred embodiment thereof with reference to the accompanying drawings, in which:

FIG. 1 is a perspective view of a tape dispenser having a spool of the insect removal tape thereon;

FIG. 2 is a perspective view of a handheld roller for dispensing the insect removal tape;

FIG. 3 is a detailed view of the insect removal tape;

FIG. 4 is a perspective view of the insect removal tape after removing an insect;

FIG. 5 is a perspective view of another handheld roller; and

FIG. 6 is a perspective view of a roll of tape to be disposed on the handheld roller of FIG. 5.

### DETAILED DESCRIPTION OF THE PREFERRED EMBODIMENT

The present invention was conceived in response to the invasion of the tick insect, or any other small insect that annoys and disturbs the public health.

With the present invention, the insect is immobilized on the surface of the animal, person or inanimate object upon contact with the tape. In particular, the insect sticks to the tape due to the adhesive characteristic of the tape. In addition, the tape is provided with an agent that debilitates and/or kills the insect. Only a small amount of the agent is necessary to affect the insect.

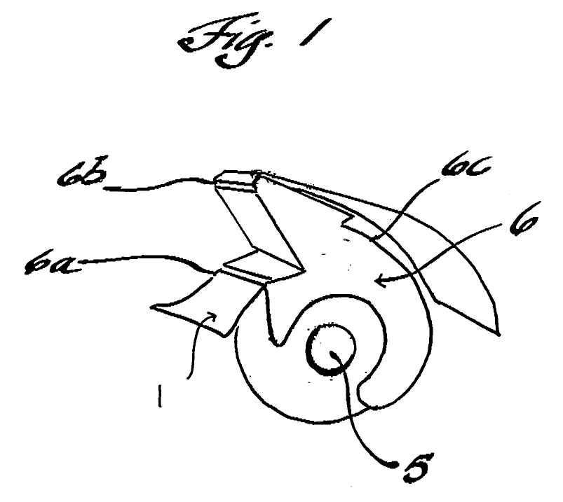

Referring to FIG. 1, a tape dispenser 6 is shown with a spool 5 of insect removal tape 1. The dispenser 6 has a portion 6a for dispensing an end of the tape 1. A serrated blade 6b may be provided for cutting the tape so that a desired length of tape 1 is dispensed from the spool 5.

The dispenser 6 may be designed in a number of shapes and colors. The dispenser may be tooled to resemble a particular animal, such as a cat, dog, etc. The dispenser may be designed to have a portion 6c which will clip onto a belt or pocket, so that the operator can devote both hands to tearing off the tape and applying the tape to the surface. This hands-free operation is particularly important when the tape is being applied to an animal and one hand is needed to hold the animal still.

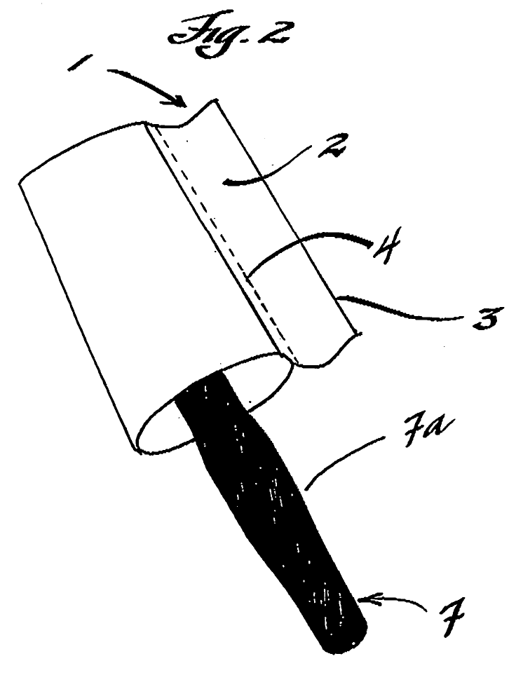

FIG. 2 illustrates an alternative device for dispensing the insect removal tape 1. In particular, FIG. 2 shows a handheld roller 7 provided to hold the spool 5 of tape 1. A convenient handle 7a is provided so that the insect removal tape 1 can easily be unrolled and applied to the desired surface. The handle 7a may vary in texture and size and may be contoured for hand comfort. The different methods for using the handheld roller are described later.

The dispenser 6 and handheld roller 7 may be designed so that a refill roll of tape can be accommodated thereon when the current roll of tape is used up.

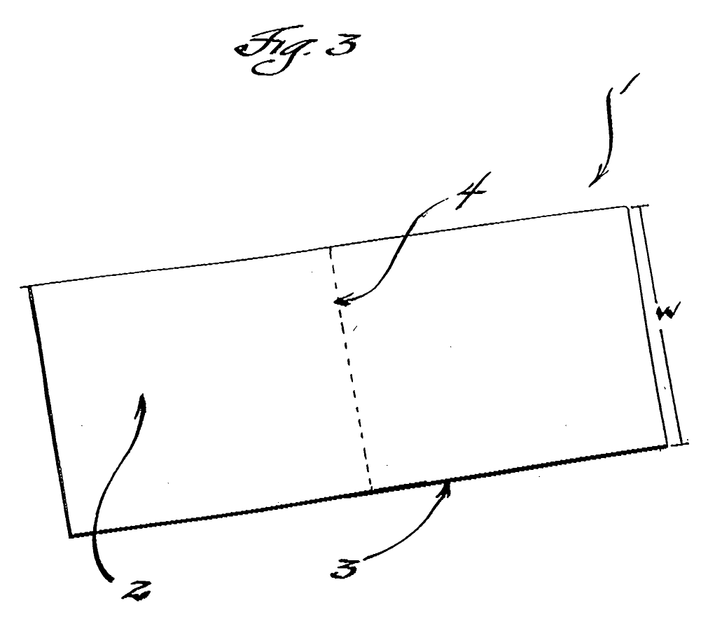

FIG. 3 illustrates the insect removal tape 1. A first side 2 of the tape has an adhesive applied thereto, to facilitate the sticking of the tape to the animal's surface and the insect. The stickiness of the adhesive also serves to immobilize the insect. The second side 3 of the tape is not sticky, to allow for easy handling of the tape.

An active ingredient for killing the insect is also provided on the first side. The active ingredient may be any ingredient that effectively debilitates, immobilizes or kills insects without harming animals, since the tape may applied directly to the animal. Possible active ingredients include camphor, menthol, alcohol, eucalyptus oil, phenol, etc. Preferably, but not necessarily, the active ingredient is not a pesticide and is safe for animals and children, i.e., people friendly.

The above ingredients may be used singularly or in combination with each other. Possible combinations which have been shown to debilitate and/or kill insects include: (1) camphor 10.8%, phenol 4.7%, eucalyptus oil 10-70% and light mineral oil ˜10%; (2) alcohol 10-70% and inactive ingredients; and (3) menthol 2.6%, camphor 4.8% and eucalyptus oil 1.2%.

Other active ingredients may be combined with the above. Such active ingredients include, but are not limited to: topical analgesics, cedar leaf oil, nutmeg oil, petroleum and thymol.

Possible inactive ingredients include, but are not limited to: denatonium/benzoate, methyl, isobutyl, ketone and water.

The active ingredient may cover the entire surface of the adhesive side of the tape, or it may only be present on a portion of the surface of the tape. For instance, the active ingredient may be provided only along the perimeter edges of the tape. Moreover, the active ingredient may be layered over the adhesive, under the adhesive or embedded in the adhesive material.

In addition, the active ingredient may be stored within an interior cavity of the spool of the dispenser. By storing the active ingredient in the spool, the active ingredient is emitted in a vapor and helps intoxicate the insect.

As shown in FIG. 3, the tape 1 may have perforations 4 to facilitate easy tearing of the tape from the dispenser. However, this is not necessary since any means for cutting the tape may be used, such as scissors, etc.

The preferable width “w” of the tape is approximately 2″. However, other sizes may utilized if a smaller or larger area needs to be tended to.

Although the tape may be any color, light colored or clear tape allows for easy visibility of the surface and the insect after the tape has been applied to the surface.

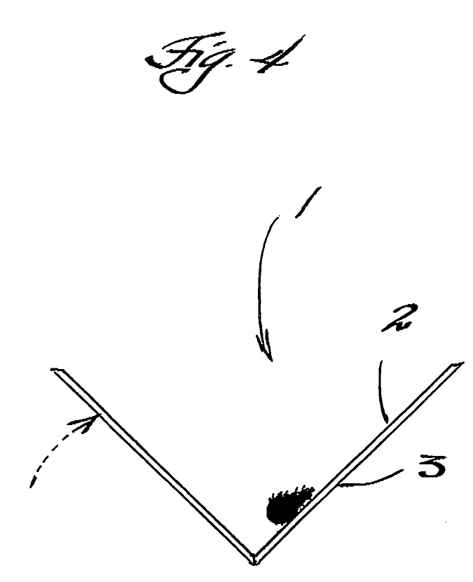

With the present invention, one does not have to touch the insect or risk getting bitten. The tape 1 can be easily removed from the surface and folded in half so that the insect is disposed on the inside of the tape, as illustrated in FIG. 4. The insect is completely covered and the tape can easily be discarded without risk.

Specifically, according to a method of using the present invention, a desired amount of tape 1 is adhered to a surface, such as the surface of an animal which has an insect disposed thereon. The tape is applied so that the insect contacts the tape. The adhesive side of the tape should face the insect so that the insect is immobilized. After a predetermined amount of time the tape should be removed from the animal. This predetermined amount of time may allow for the insect to be debilitated or killed. The tape is then folded in half so that the insect is disposed within the folded tape.

The handheld roller 7 may be used in several ways. For instance, the roller may be pressed against a surface and rolled along the surface so that any insects on the surface immediately stick to the tape while it is still wound on the roller. With this use, the tape is then removed from the roller with the insect attached thereto. As discussed above, the active ingredient may be stored in the spool 5 of the roller, and this would allow the vapor to help debilitate the insect being stuck on the tape.

In another use, the roller may be pressed against a surface and rolled along the surface so that the tape unrolls from the roller and sticks to the surface. A predetermined amount of tape is torn or cut off from the supply of tape on the handheld roller. Here, the tape is removed from the roller similar to the use of the dispenser 1 discussed above. In this case, the tape is removed from the surface after the tick has adhered to the tape.

The handheld roller can also be used so that the tape remains on the roller. Here, the insect removal tape remains on the handheld roller and the insects are rinsed off the tape while the tape remains on the roller. Again, the active ingredient may be stored in the spool 5 of the roller so that the vapor debilitates the insect stuck to the tape.

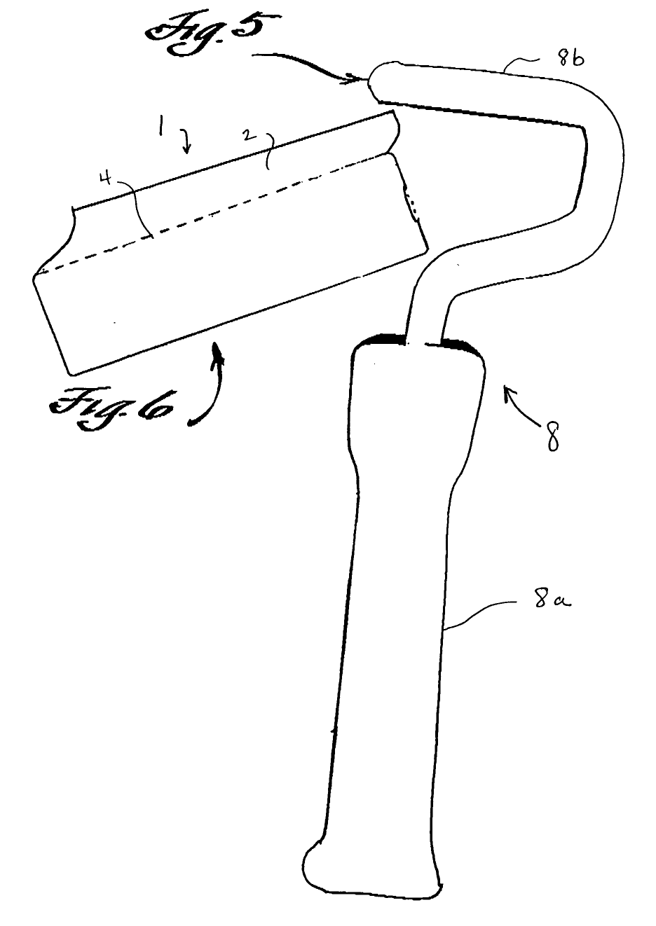

FIGS. 5 and 6 illustrate another type of handheld roller. Specifically, a handheld roller 8 is provided with a handle 8a having a longitudinal axis which is perpendicular to the longitudinal axis of the spool of tape. The spool 5 of tape 1 which is to be disposed on the handheld roller 8 is illustrated in FIG. 6. This handheld roller embodiment allows the tape to be rolled onto a surface in a vertical motion. As illustrated by FIG. 6, refill spools 5 of tape 1 can be easily loaded onto a rotating spindle 8a of the handheld roller 8 as needed. The handle 8a may include various textures and sizes, as well as contours, to provide a comfortable grip.

As with the handheld roller 7, the handheld roller 8 can be used in the different ways discussed above. For example, the tape can remain on the roller and the insect rinsed off the tape, which would allow the tape to be reused. Alternatively, the tape can be removed from roller after the insect has adhered to the tape. Also, the tape can be unwound from the roller as the roller is pressed against the surface having the insect.

With the present invention a large surface area can be covered in only a few seconds. Thus, insects can be removed quickly and easily with little effort since the insect is securely sealed to the adhesive surface.

The present invention is intended to include any type of device having an adhesive quality that is capable of immobilizing or killing an insect. Such devices include rubberized adhesive rollers, or other comparable roller-type devices which have an adhesive or tacky surface which is capable of immobilizing an insect. Thus, tape does not have to be used since any device, e.g., a roller, can be provided with an adhesive quality that would be capable of immobilizing or killing an insect. Instead of tearing away the tape to discard the insect, the adhesive roller or similar device can simply be rinsed in order to discard the attached insect.

With this type of rubberized adhesive surface, or any other type of reusable surface, a low cost and environmentally friendly alternative is possible since the same adhesive surface is reused again and again. Of course, the reusable rubberized adhesive roller or similar device can be used in either of the handheld rollers disclosed above or equivalents thereof.

Also, the present invention is intended to include other chemical solutions in addition to those described above. Any chemical solutions which are formed of the phenol group, for example, could be used in the solution.

It will be apparent to those skilled in the art that various modifications and variations can be made according to the present invention without departing from the spirit or scope of the invention. Thus, it is intended that the present invention cover the modifications and variations of the invention provided they come within the scope of the appended claims and their equivalents.

1. A method for removing insects from a surface, comprising the steps of:
placing a piece of tape on the surface on which an insect is present so that one side of the tape contacts and adhesively immobilizes the insect, wherein said one side of the tape includes a chemical agent for debilitating the insect;
removing the tape from the surface; and
folding the tape in half so that the insect is disposed inside the folded tape.

2. The method according to claim 1, wherein said chemical agent is capable of killing insects.

3. The method according to claim 1, wherein the tape is disposed on a handheld roller and the tape is applied to the surface by pressing the handheld roller against the surface and then rolling the handheld roller on the surface so that the insect adheres to the tape while the tape remains on the handheld roller.

4. The method according to claim 3, further comprising the step of removing a piece of the tape having the insect adhered thereto from the handheld roller before the step of folding the tape.

5. The method according to claim 3, further comprising the step of rinsing the insect off of the tape on the handheld roller.

6. An insect removal tape, comprising;
a tape having a first side including an adhesive layer thereon to facilitate sticking of the tape to a surface and an insect;
said tape further having a second side which is not sticky, to permit application of said tape to said surface and said insect by hand, and subsequent removal of said tape with said insect adhered thereto, from said surface; and
said first side further including a chemical agent for debilitating said insect.

7. The insect removal tape according to claim 6, wherein said chemical agent includes one of camphor, menthol, eucalyptus oil and alcohol.

8. The insect removal tape according to claim 6, wherein said tape has perforations for facilitating tearing off a portion of said tape.

9. The insect removal tape according to claim 6, wherein said tape is wound on a spool which is disposed on a dispenser.

10. The insect removal tape according to claim 9, wherein said dispenser is a handheld roller.

11. The insect removal tape according to claim 9, wherein said chemical solution is disposed within an interior portion of said spool so that said chemical solution emanates from said spool in vapor form for facilitating the debilitation of insects.

12. A device for removing insects from a surface, comprising:
an adhesive tape for adhesive application to a surface and an insect; and
an active ingredient, disposed on said tape, for debilitating the insect; and
a dispenser for dispensing said tape.

13. The device according to claim 12, wherein said active ingredient is disposed along only the peripheral edge of said adhesive tape.

14. The device according to claim 12, wherein said active ingredient is disposed on only one side of said adhesive tape.
